(19) United States
(12) Patent Application Publication
(10) Pub. No.: US 2016/0299955 A1
(43) Pub. Date: Oct. 13, 2016

(54) TEXT MINING SYSTEM AND TOOL

(71) Applicant: MuSigma Business Solutions Pvt. Ltd., Bangalore (IN)

(72) Inventors: Gaurav Jain, Bangalore (IN); Deepinder Dhingra, Bangalore (IN); Zubin Dowlaty, Georgetown, TN (US); Bharat Upadrasta, Bangalore (IN)

(21) Appl. No.: 14/828,390

(22) Filed: Aug. 17, 2015

(30) Foreign Application Priority Data
Apr. 10, 2015 (IN) 1879/CHE/2015

(51) Int. Cl. G06F 17/30; G06F 3/0484

(52) U.S. Cl. CPC G06F 17/30539; G06F 3/0484; G06F 17/30312; G06F 17/30554

(57) ABSTRACT

A text mining system for extracting relevant text from a plurality of input data sets is provided. The text mining system includes an input interface module configured to enable one or more users to select a plurality of sources for a plurality of input data sets. The text mining system also includes a text analysis module configured to receive the plurality of input data sets and to generate an output data set by analyzing the plurality of input data sets. The text analysis module includes a data handling module configured to convert the plurality of input data sets to an analytics text set. The text analysis module also includes an exploratory analysis module configured to determine a plurality of correlations within the analytics text set. The text analysis module further includes a topic modeling module configured to identify a plurality of topics repeatedly occurring in the analytics text set and a reporting module configured to generate a plurality of reports for the text analysis module. The text mining system further includes memory circuitry configured to store the plurality of input data sets, the analytics text set and the output data set.

### BACKGROUND

The invention relates generally to text mining systems, and more particularly to a system and tool for deriving relevant information from text derived from several sources.

Text mining, sometimes alternately referred to as text data mining, or text analytics, refers to the operation of deriving relevant information from text received from several sources. Typical text mining tasks include text categorization, text clustering, concept or entity extraction, production of granular taxonomies, sentiment analysis, document summarization, and entity relation modeling among others.

Text mining systems can be used to build large dossiers of information about specific events. Text mining can be broadly applied to fulfill a wide variety of research and business needs in various fields such as security, biomedical, online media, marketing sentiment analysis, academics and software, etc. Moreover, text mining can also be used in certain email spam filters as a way of determining the characteristics of messages that are likely to be advertisements or other unwanted material.

However, with the current text mining systems the end user of an analytic application must be sufficiently skilled to accomplish all the tasks, some of which require substantial expertise and hence turns out to be expensive affair. Also, the huge amount of data collected in text mining is mostly semi-structured, unstructured and ill-organized that contains lexical, syntactic and semantic ambiguities. The available text mining tools use text-based searches, which can only find documents containing specific user-defined words or phrases and requires human intervention to interpret the information and to turn it actionable.

Therefore, it is desirable to automate text mining, thus reducing the need for the users to have special expertise in the field.

### SUMMARY

Briefly, according to one aspect of the invention, a text mining system for extracting relevant text from a plurality of input data sets is provided. The text mining system includes an input interface module configured to enable one or more users to select a plurality of sources for a plurality of input data sets. The text mining system also includes a text analysis module configured to receive the plurality of input data sets and to generate an output data set by analyzing the plurality of input data sets. The text analysis module includes a data handling module configured to convert the plurality of input data sets to an analytics text set. The text analysis module also includes an exploratory analysis module configured to determine a plurality of correlations within the analytics text set. The text analysis module further includes a topic modeling module configured to identify a plurality of topics repeatedly occurring in the analytics text set and a reporting module configured to generate a plurality of reports for the text analysis module. The text mining system further includes memory circuitry configured to store the plurality of input data sets, the analytics text set and the output data set.

In accordance with another aspect, a text mining tool for extracting relevant text from a plurality of input data sets is provided. The text mining tool includes an input interface module configured to enable a user to select a plurality of sources for a plurality of input data sets and a data handling interface configured to enable the user to select one or more variables to trigger a data handling task. The data handling task converts the plurality of input data sets to an analytics text set. The text mining tool also includes an exploratory analysis interface configured to enable the user to select one or more types of analysis to trigger exploratory analysis task. The exploratory analysis task determines a plurality of correlations within the analytics text set. The text mining tool further includes a topic modeling interface configured to enable the user to select one or more input parameters to trigger topic modeling task. The topic modeling task identifies a plurality of topics repeatedly occurring in the analytics text set and a reporting interface configured to generate a plurality of reports based on selected criteria.

In accordance with yet another aspect, a method for extracting relevant text from a plurality of input data sets is provided. The method includes selecting a plurality of input data sets from a plurality of sources and converting the plurality of input data sets to generate an analytics text set. The method also includes determining correlations existing within the analytics text set by performing exploratory analysis and generating one or more models based on the results of the exploratory analysis. The method further includes performing topic modeling to identify repeatedly occurring topics in the analytics text set, generating a plurality of reports based on selected criteria and generating an output data set.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a text mining system implemented according to aspects of the present technique;

FIG. 2 is a flow diagram of one method of extracting relevant text from the input data sets using a text mining system implemented according to aspects of the present technique;

FIG. 3 is a block diagram of an example text analysis module implemented according to aspects of the present technique;

FIG. 4 is a flow diagram of one method of categorizing an analytics text set implemented according to aspects of the present technique;

FIG. 5 is an example home screen of a text mining tool implemented according to aspects of the present technique;

FIG. 6A through 6C are example data handling screens of a text mining tool implemented according to aspects of the present technique;

FIG. 7 is an example exploratory analysis screen of a text mining tool implemented according to aspects of the present technique;

FIGS. 8A and 8B are example report generation screens of a text mining tool implemented according to aspects of the present technique;

FIG. 9 is an example text categorization screen illustrating model definition of a text mining tool implemented according to aspects of the present technique;

FIG. 10 is an example model building screen of a text mining tool implemented according to aspects of the present technique;

FIG. 11 is an example model diagnostic screen of a text mining tool implemented according to aspects of the present technique;

FIG. 12 is an example iteration history viewing screen of a text mining tool implemented according to aspects of the present technique;

FIG. 13 is an example topic modeling screen of a text mining tool implemented according to aspects of the present technique;

FIG. 14 is an example topic distribution chart viewing screen of a text mining tool implemented according to aspects of the present technique; and

FIG. 15 is a block diagram of a general purpose computer arranged for extracting relevant text from a plurality of input data sets implemented according to aspects of the present technique.

### DETAILED DESCRIPTION

The present invention provides a text mining system configured to extract relevant text from input data sets to enable accurate data analysis. The text mining system derives relevant information from text by structuring the input text, deriving patterns within the structured text, evaluation and interpretation of the structured text. In the example embodiment, text mining technique includes various tasks like data handling, exploratory analysis, text categorization, topic modeling and report generation. These tasks can be performed separately as per requirement and need not follow the sequence as specified.

References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

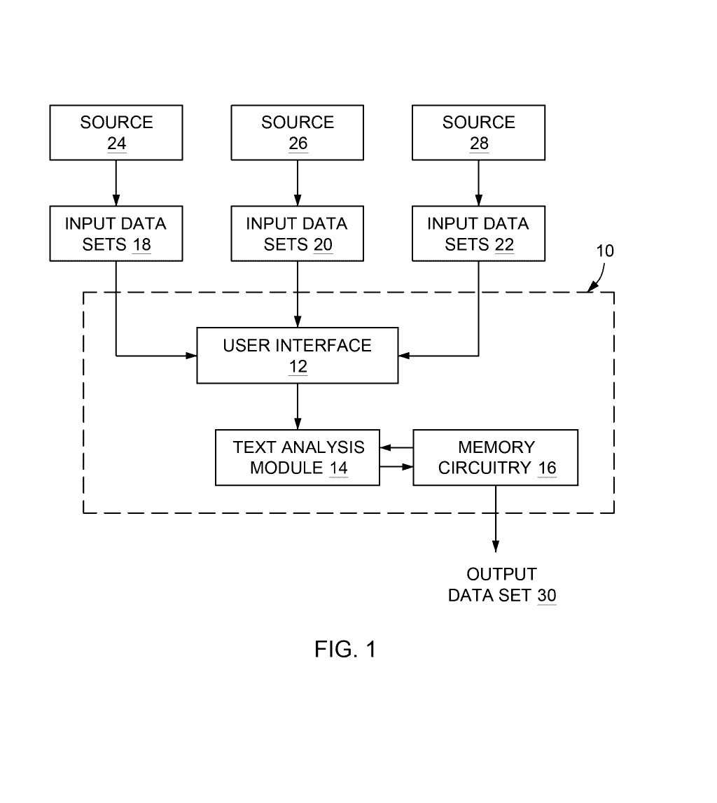

FIG. 1 is a block diagram of a text mining system implemented according to aspects of the present technique that is arranged for extracting relevant text from input data sets in accordance with the present technique. The text mining system 10 typically includes a user interface 12, a text analysis module 14 and memory circuitry 16. Each component is described in further detail below.

The text mining system 10 is configured to receive input data sets 18, 20, 22 from several sources 24, 26 and 28. Examples of input data sets include substantially large amount of text, alphanumeric data etc. obtained from several sources like social media platforms, sales and marketing channels, financial reports and the like. For the purposes of this specification and claims, the term “social media platform” may relate to any type of computerized mechanism through which persons may connect or communicate with each other. Some social media platforms may be applications that facilitate end-to-end communications between users in a formal manner. Other social networks may be less formal, and may consist of a user's email contact list, phone list, mailing list, or other database from which a user may initiate or receive communication. Also, it may be noted that, the term “user” may refer to both natural people and other entities that operate as a “user”. Examples include corporations, organizations, enterprises, teams, or other group of peoples.

The user interface 12 is configured to enable a user to provide a set of keywords for a pre-defined operation. Input data sets related to the keywords are obtained from several sources generally referred by reference numerals 24, 26, 28. Examples of sources are social media networks such as Twitter, Facebook, etc., business reports from various business units, trends and predictions from specific stock markets, and the like.

Text analysis module 14 is coupled to the user interface 12 and is configured to receive the input data sets 18, 20, 22 derived from the keywords specified by the user and generates an output data set 30 by perusing the input data sets. The output data set 30 refers to the relevant text extracted from the input data sets. The text analysis module 14 performs various operations like data handling, exploratory analysis, text categorization, topic modeling and report generation related to the selected keywords to extract relevant text from the input data sets 18, 20, 22. The text analysis module 14 is further configured to provide language compatibility by allowing the user to select the input data sets from a plurality of languages.

Memory circuitry 16 is coupled to the text analysis module 14 and is configured to store the input data sets 18, 20, 22 and the output data set 30. The manner in which relevant text is extracted from the input data sets 18, 20, 22 is described in further detail below.

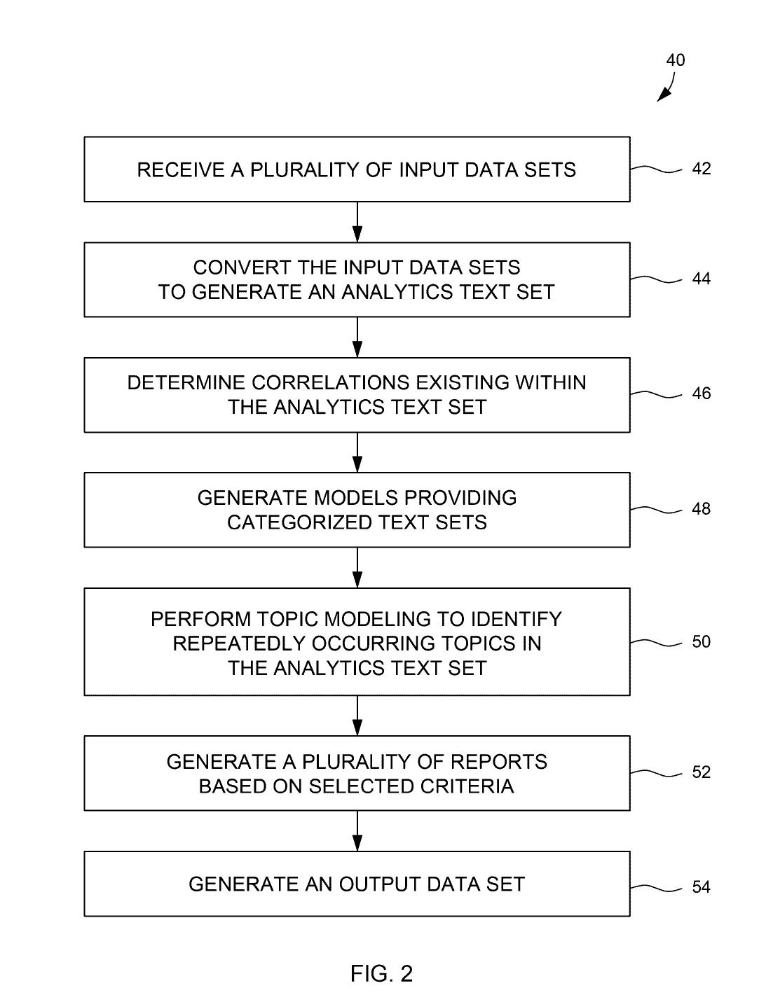

FIG. 2 is a flow diagram of one method for extracting relevant text from the input data sets using a text mining system implemented according to aspects of the present technique. The input data sets may be derived from various social media platforms as described above. Each step of the process is described below.

At block 42, the input data sets derived from the keywords specified by the user are received. The keywords are provided by the user via user interface 12. In general, the input data sets may include keywords for a certain product, the product name, a name of a business or an organization, and the like. In one embodiment, the input data sets can be in any language based on the language preference specified by the user. Examples of the languages include, but are not limited to, English, German, Spanish, Portuguese, French, and the like.

At block 44, the input data sets are converted to an analytics text set. In one embodiment, the input data sets are pre-processed to filter non-relevant text by performing a data handling task. For example, stop words, special characters, phone numbers, URL's, white spaces, email addresses etc. are some of the example non-relevant text that is removed from the input data sets. In another example, non-relevant text such as nouns, verbs, adjectives, etc. are either removed or grouped together to form the analytics text set.

At block 46, exploratory analysis is performed to determine correlations existing within the analytics text set. Exploratory analysis establishes the intricacies relationships existing amongst the input data sets. Examples of exploratory analysis include frequency analysis and relationship analysis.

At block 48, one or more models providing one or more categorized text sets are generated based on the results of the exploratory analysis. Each model provides one or more categorized text sets to achieve a pre-defined goal determined by the user. The process of text categorization includes recognizing inherent structure in the analytics text set and grouping variables together by similarity into one or more categories.

At block 50, topic modeling is performed to identify frequently appearing topics in the analytics text set. The analytics text set can either be a categorized text set or a non-categorized text set. The topics are identified based on several themes present in the analytics text sets. The process captures the identification of repeatedly occurring text in a mathematical framework, to allow examining the analytics text set based on the statistics of the words, identifying the topic and determining the balance of topics in each analytics text set. Further, a relative importance of each word within a topic is determined.

At block 52, several reports are generated based on desired criteria provided by the user. Multiple reports can be generated at various stages of the process flow. Different reports can be viewed at one place in reporting framework and results can be compared across reports with ease.

At block 54, an output data set is generated based on the results of exploratory analysis, categorization and topic modelling steps described above. The generated output data set is then used for various analytic operations. The manner in which the text analysis module operates is described in further detail below.

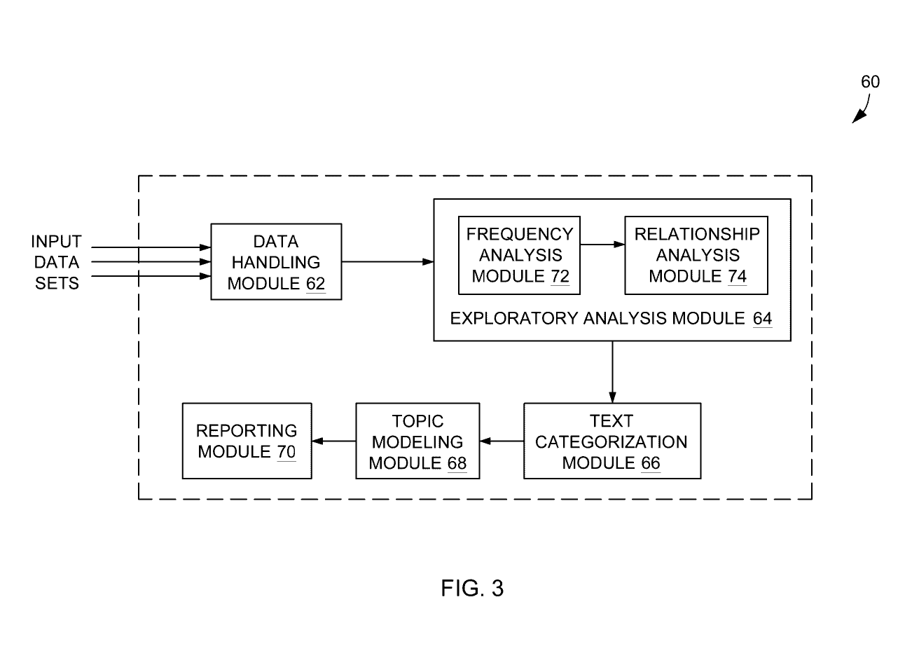

FIG. 3 is a block diagram of an example text analysis module implemented according to aspects of the present technique. The text analysis module 60 includes a data handling module 62, an exploratory analysis module 64, a text categorization module 66, a topic modeling module 68 and a reporting module 70. Each component is described in further detail below.

Data handling module 62 is configured to convert the input data sets to an analytics text set. The data handling module 62 performs this operation by cleaning up the input data sets. In one embodiment, the data handling module 62 is configured to perform a pre-processing task by filtering non-relevant elements from the input data sets. The input data sets provided by the user can be in any language based on the language preference specified by the user. Examples of the languages include, but are not limited to, English, German, Spanish, Portuguese, French, and the like. The cleaning of input data sets involves detecting, correcting or removing non-relevant text. The data handling module 62 further performs various tasks including tokenization, sentence segmentation, speech tagging, extraction of named entity, chunking, parsing, co-reference resolution and the like.

Exploratory analysis module 64 operates on the analytics text set generated by the data handling module 62 and is configured to determine a various correlations that are present within the analytics text set. In one embodiment, the exploratory analysis module 64 further includes a frequency analysis module 72 and a relationship analysis module 74 which is described in further detail below.

Frequency analysis module 72 is configured to perform detailed analysis of the analytics text set. The detailed analysis includes operations such as the removal of sparse terms, identification of words with minimum threshold frequency for analysis, identification of most frequently occurring unigrams or bigrams (combination of two words) and identification of top terms in the analytics text set.

Relationship analysis module 74 is configured to determine a frequency of occurring keywords depending on the variables, parts of speech and number of top keywords. In one example embodiment, on selection of any top keyword by the user, the associated words in the analytics text set are searched. For each of the associated word in the analytics text set an associated score is calculated. The associated score indicates the strength of association that exists between other words with the selected one. Further, parameters like term frequency indicating the number of occurrences of a particular term in the analytics text set is also calculated.

Text categorization module 66 is configured to generate a plurality of models of the analytics text set based on the results of the exploratory analysis module 64. As mentioned earlier, the analytics text set can either be a categorized text set or a non-categorized text set. The text categorization module 66 performs several operations like model building, model diagnostics, predict and iteration history using machine learning models.

In one embodiment, the text categorization is performed by first manually categorizing a subset (e. g. a sample data set) of the analytics text set. The text categorization module 66 categorizes the analytics text set by creating an actual categorization module by identifying a plurality of categories for sample data set and then creates a predictive categorization module by applying the identified categories on the analytics text set. The text categorization module 66 further compares the actual categorization module and the predictive categorization module in an iterative manner.

The parameters used for manual categorization is then extrapolated to the remainder of the analytics text set. In one embodiment, supervised machine learning algorithms are applied to the analytics text set. The supervised machine learning can be customized using machine learning rules or manually coded rules. For example, models can be created during model building by using training data and algorithms like support vector machine (SVM), random forest, GLMNET, and maximum entropy etc.

Topic modeling module 68 is configured to identify a plurality of topics repeatedly occurring in the analytics text set. Topic modeling module 68 provides a simple way to analyze the substantially large volumes of unlabeled text. Typically, the analytics text set includes a cluster of words that frequently occur together. The topic modeling module 68 connects words with similar meanings and distinguishes between uses of words with multiple meanings using contextual clues. Further, the topic modeling module 68 identifies the hidden topical patterns that pervade the collection through statistical regularities and annotate texts with these topics. The topic annotations are further used to organize, summarize and search texts.

Topic modeling module 68 makes use of a suite of unsupervised machine learning algorithms to examine texts. In one example embodiment, Latent Dirichlet Allocation (LDA) is used. The LDA algorithm generates probabilistic mode of a corpus that allows sets of observations to be explained by unobserved groups to explain why some parts of the text are similar.

Reporting module 70 is configured to enable the user to access several reports generated by the text analysis module 60. The reports are generated in such a way so as to allow viewing topics and keywords per topic as word cloud as well as to provide possibility to view topic distribution charts. The reporting module 70 further facilitates storing the reports to enable the user to access several reports from a single location. The manner in which the analytics text set is categorized manually is described in further detail below.

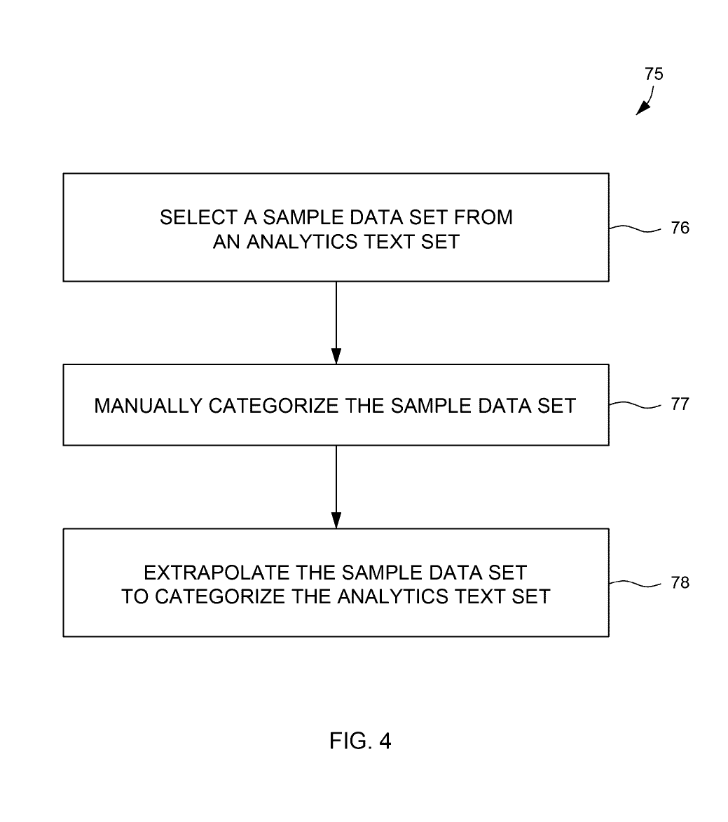

FIG. 4 is a flow diagram of one method of categorizing an analytics text set implemented according to aspects of the present technique. Each step of the process is described below.

At block 76, a sample data set is selected from analytics text set. As mentioned earlier, the sample data set is a subset of the analytics text set. At block 77, the sample data set is manually categorized using multiple parameters that are defined by the user to create an actual categorization module. The process of text categorization includes recognizing inherent structure in the input data sets and grouping variables together by similarity into one or more categories. Further, a predictive categorization module is created by applying the identified categories on the analytics text set. The actual categorization module and the predictive categorization module are compared in an iterative manner.

At block 78, the sample data set is extrapolated to categorize the remainder of the analytics text set. The extrapolation is done by performing operations like model building, model diagnostics, predict and iteration history using machine learning models. For example, models can be created during model building by using training data and algorithms like support vector machine (SVM), random forest, GLMNET, and maximum entropy etc.

The above described text mining system may be implemented as a text mining tool that is configured to execute on a computing device. The text mining tool is configured to extract relevant text from the input data sets and includes several interfaces. Some of the relevant interfaces are described in further detail below.

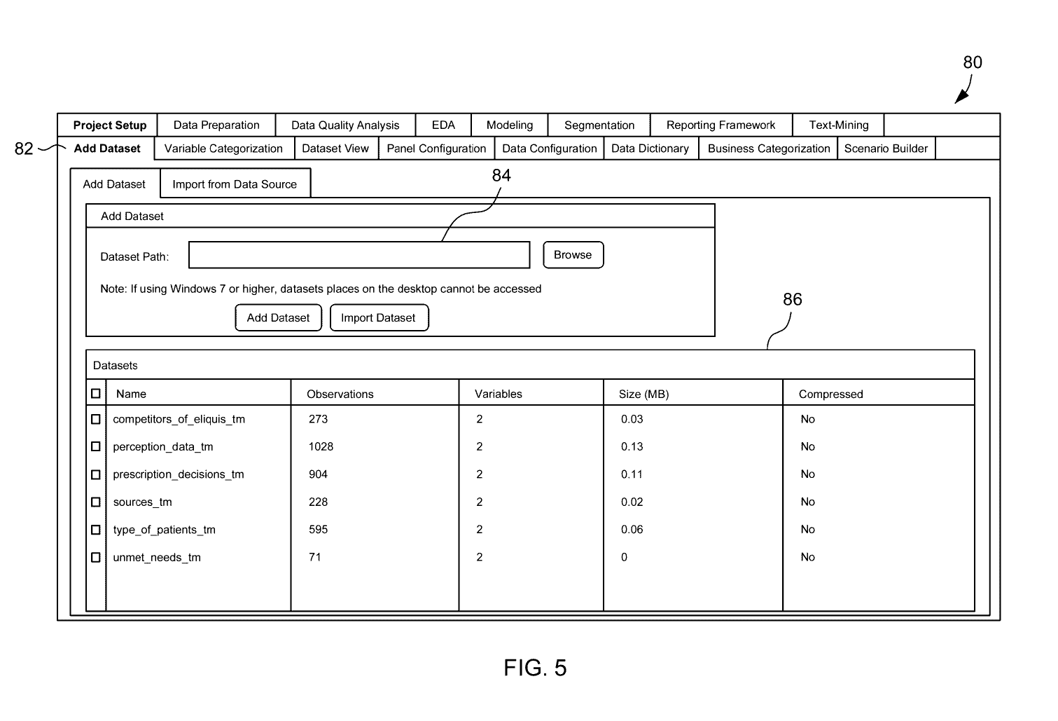

FIG. 5 is an example home screen of a text mining tool implemented according to aspects of the present technique. The home screen 80 enables the users to add an input data set by using the “ADD DATASET” tab 82. A path for the input data sets to be added can be specified through the “DATASET PATH” tab 84. Further, the various existing input data sets can be viewed using the pane 86.

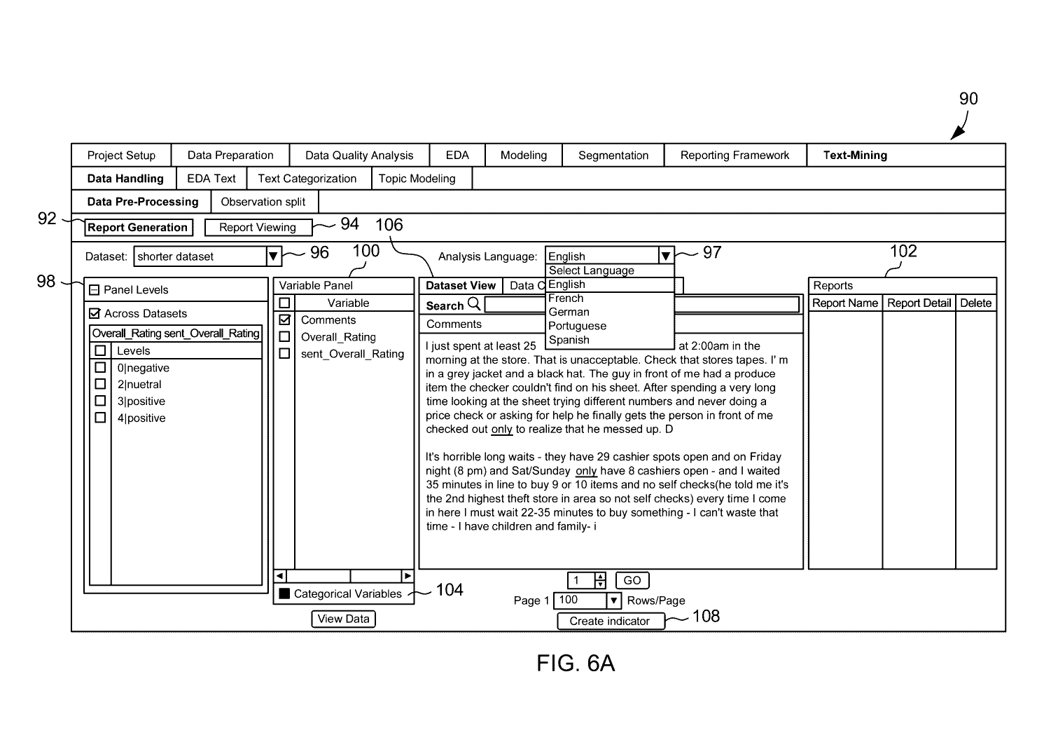

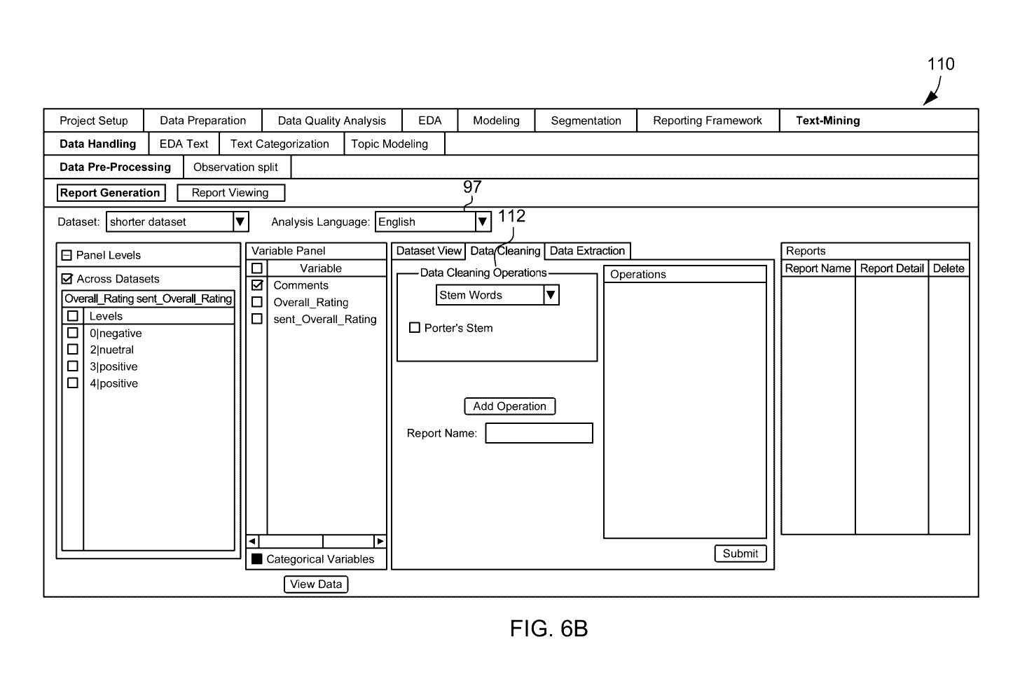

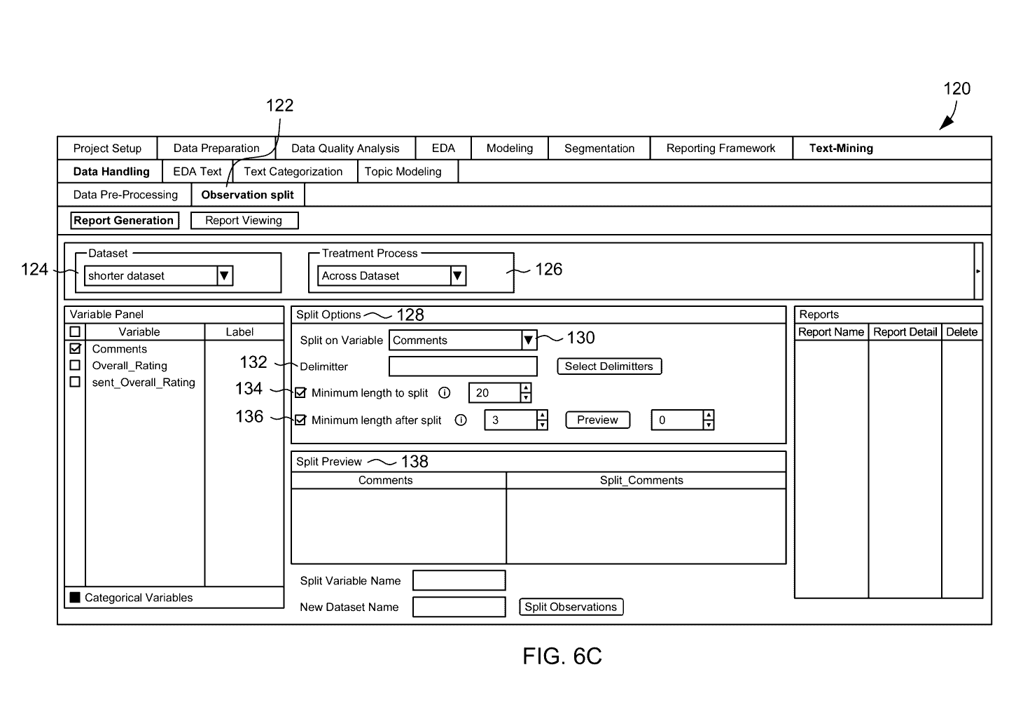

FIG. 6A through 6C are example data handling screens of a text mining tool implemented according to aspects of the present technique. The data handling screens 6A through 6C enable the user to perform several data handling operations on the input data sets to generate an analytics text set. In the illustrated embodiment, the data pre-processing screen 90 enables the user to perform operations mainly related to report generation (cell 92) and report viewing (cell 94). During report generation operations user can select input data sets using dataset field (cell 96) provided in the data pre-processing screen 90. The data handling screens 6A and 6B further enable the user to perform the operations related to data handling in a plurality of languages like English, German, Spanish, Portuguese and French based on the language preference specified by the user. The user can specify the language preference using analysis language field (cell 97). In the illustrated embodiment, the language preference specified by the user is English.

The data pre-processing screen 90 further includes panes pertaining to panel levels 98, variable panel 100, and reports 102. The variable panel 100 allows the user to select a plurality of variables including categorical variables (cell 104). Additionally, a dataset view panel (cell 106) is provided for a quick view of the data to the user for the selected variable. The dataset view panel (cell 106) also allows the user to search for a specific term in the selected variables. The user can further create an indicator variable using tab “Create Indicator” (cell 108) for the searched data that can later be used to perform analysis.

FIG. 6B illustrates a data cleaning screen 110 that enables the user to perform several data cleaning operations (cell 112). The data cleaning screen 110 facilitates the user to select new variables or manipulate existing ones. The data cleaning operations (cell 112) remove noise from the input data sets. Examples of the data cleaning operations performed include removal of phone numbers, removal of special characters, removal of stop words, removal of URLs, removal of white spaces, removal of email addresses and the like. The data cleaning screen 110 also allows the user to order a sequence of data cleaning operations and the sequence can be changed by the user as per requirement. Further, the user is allowed to create a variable at any stage/step of the ordered sequence of data cleaning operations.

FIG. 6C illustrates an observation split screen 120 that enables the user to perform observation split (cell 122) by splitting the input data sets on the basis of certain delimiters provided by the user. The input data sets after split can further be used for performing analysis. The observation split (cell 122) allows better understanding of the sentiments/categories present in the input data sets. An input data set and a treatment process is chosen using dataset (cell 124) and treatment process (cell 126) fields respectively. The several split options (cell 128) are specified using fields pertaining to split on variable (cell 130), delimiter (cell 132), minimum length to split (cell 134), and minimum length after split (cell 136). The split preview pane (cell 138) provided in the observation split screen 120 facilitates the user to preview the comments related to the selected split options.

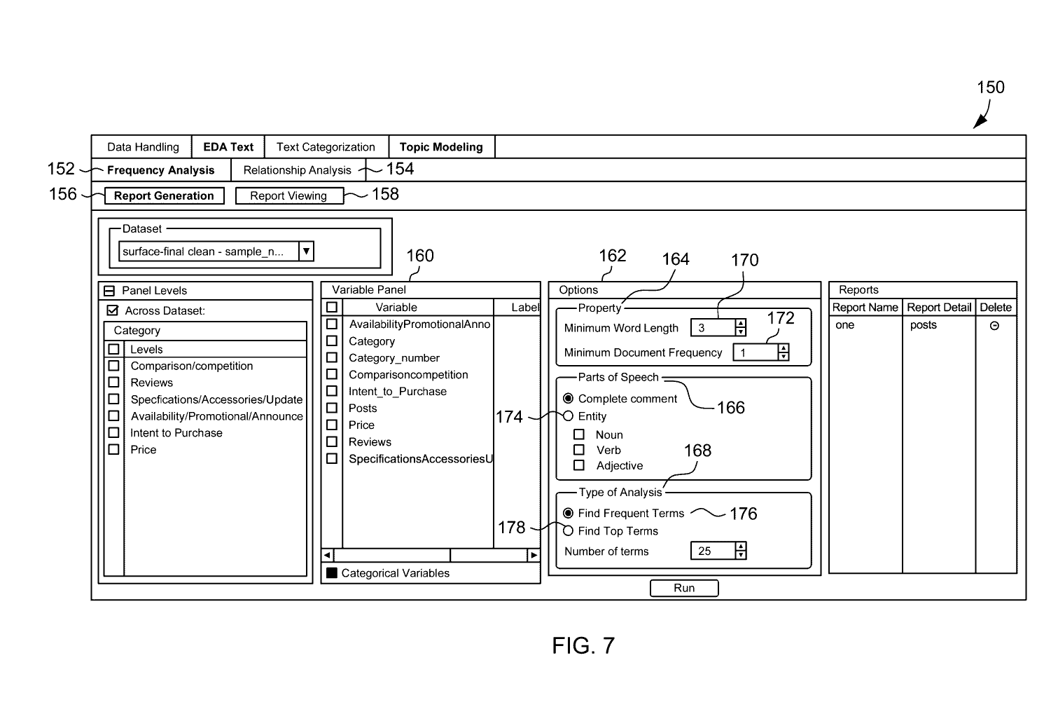

FIG. 7 is an example exploratory analysis screen of a text mining tool implemented according to aspects of the present technique. In the illustrated embodiment, the exploratory analysis screen 150 includes frequency analysis (cell 152) and relationship analysis (154). Each of the frequency analysis (cell 152) and relationship analysis (154) further includes fields pertaining to report generation (cell 156) and report viewing (cell 158).

The frequency analysis (cell 152) does a detailed analysis of the analytics text set and performs some of the actions like removal of sparse terms, identification of words with minimum threshold frequency for analysis, identification of most frequently occurring unigrams or bigrams (combination of two words) and identification of top terms. In the example embodiment, user can select a variable using variable panel 160 along with several options from options pane 162. The several options provided in the options pane 162 include property (cell 164), parts of speech (cell 166) and type of analysis (cell 168). The user can specify parameters like minimum word length (cell 170), minimum document frequency (cell 172), type of entity (cell 174), frequent terms (cell 176) and top terms (cell 178).

The relationship analysis (cell 154) generates and displays frequency of occurring keywords depending upon the variable, parts of speech and number of top keywords selected by the user.

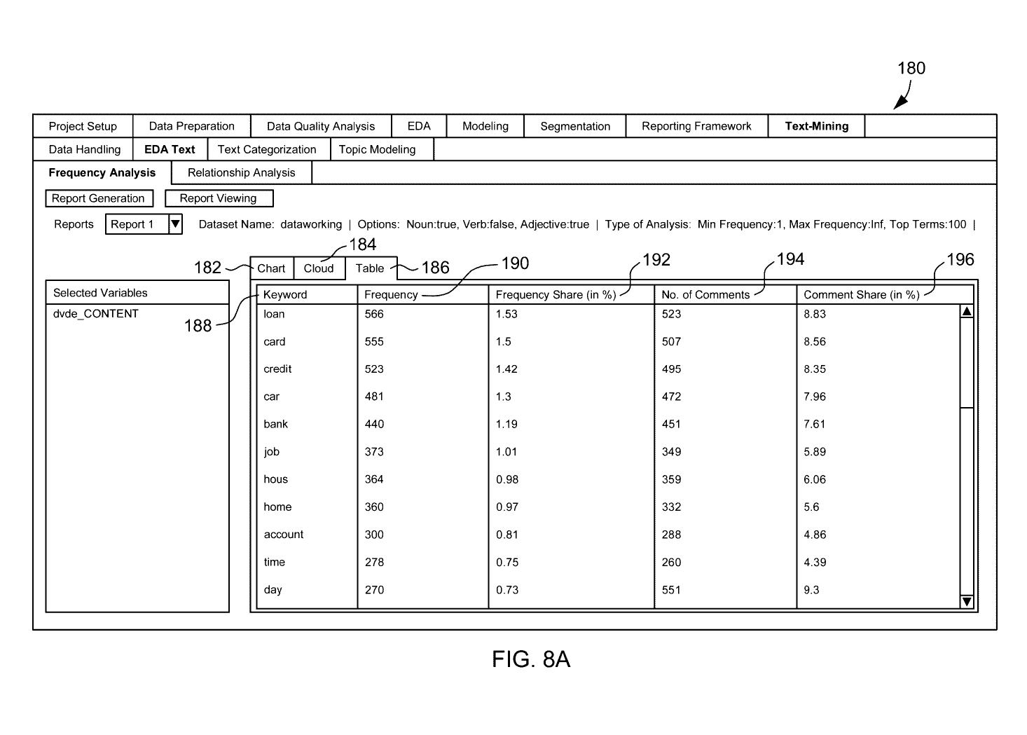

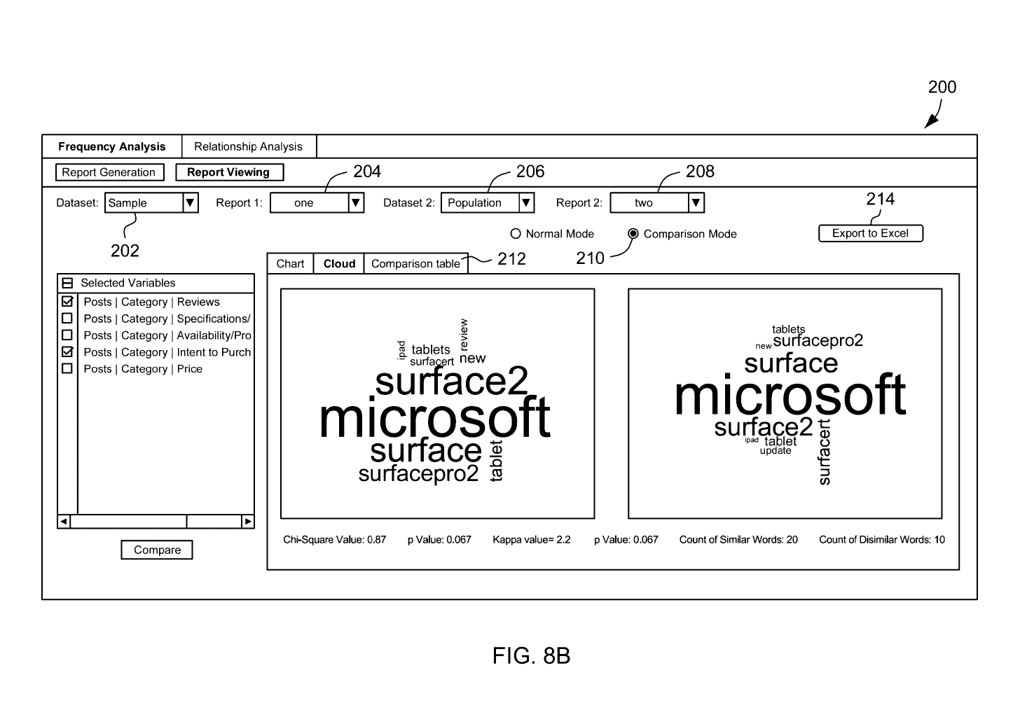

FIG. 8A is an example report generation screen 180 of a text mining tool implemented according to aspects of the present technique. As illustrated, the report generated on performing the frequency analysis can be viewed in form of several visualizations like bar chart (cell 182), text tag cloud (cell 184) or tables (cell 186). Several parameters related to the frequency analysis are viewed in the tabular form like keywords (cell 188), frequency (cell 190), frequency share (cell 192), number of comments (cell 194) and comment share (cell 196).

FIG. 8B illustrates a comparison screen 200 that enables the user to compare between two frequency analysis operations performed on two different input data sets. The input data sets and respective reports for comparison can be selected through selection fields provided in the screen 200 represented by reference numerals 202 thorough 208. The comparison mode is selected using radio button 210 and viewed using comparison table (cell 212). The comparison results highlight the key comparison attributes like count of similar words, count of dissimilar words, kappa value, chi-square value and the like. The comparison screen 200 provides option to the user to export the comparison results in various user friendly formats (tab 214).

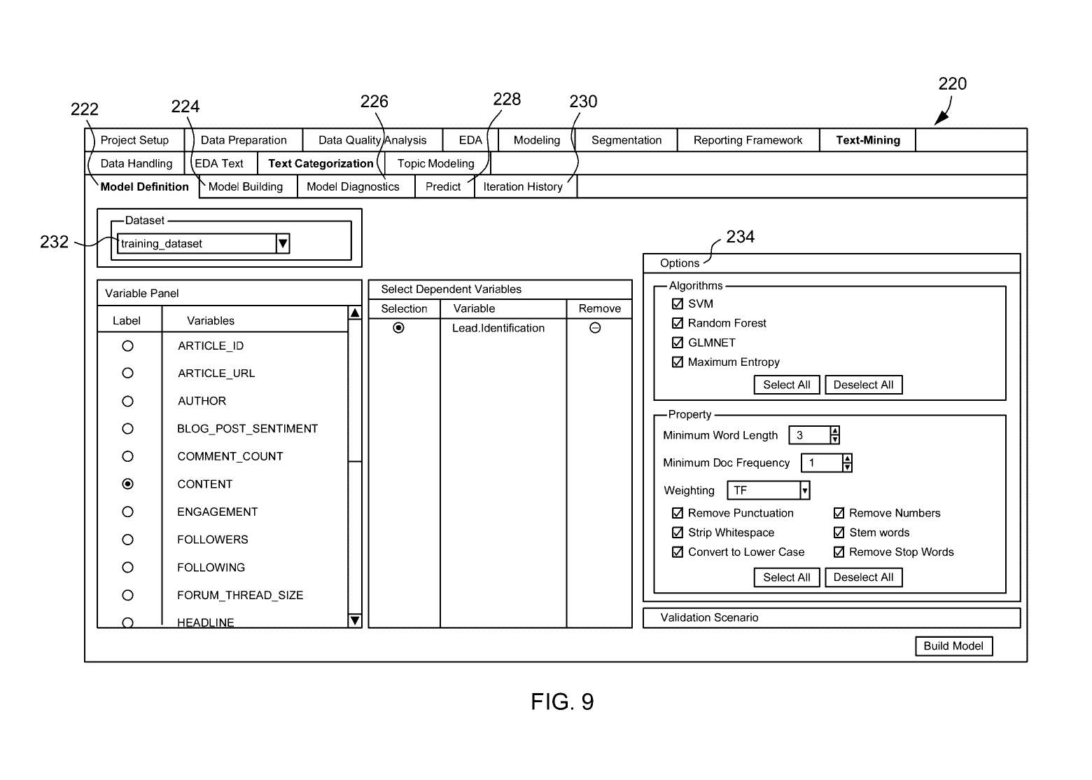

FIG. 9 is an example text categorization screen illustrating model definition of a text mining tool implemented according to aspects of the present technique. The text categorization screen 220 includes several fields pertaining to model definition (cell 222), model building (cell 224), model diagnostics (cell 226), predict (cell 228) and iteration history (cell 230). On invoking the model definition (cell 222) tab, several machine learning models can be created using a training data set (cell 232) and various algorithms available in the “options” field 234 like support vector machines (SVM), random forest, GLMNET, and maximum entropy and the like. The training data set 232 includes an exhaustive set of all the variables along with the final result variable containing specified categories. For example, the variables may depict the unique words of the document while required categories may depict the sentiment class like positive, negative and neutral.

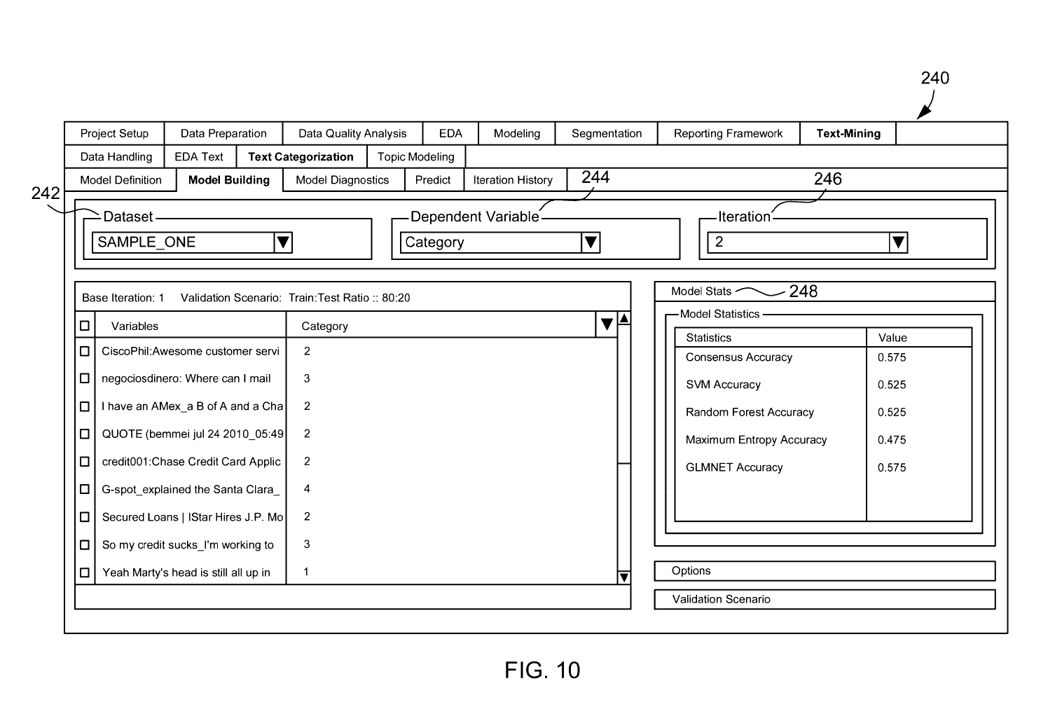

FIG. 10 is an example model building screen of a text mining tool implemented according to aspects of the present technique. The model building screen 240 includes several fields pertaining to the selection of input data sets (cell 242), dependent variables (cell 244) and number of iterations (cell 246). The model building screen 240 further includes a pane 248 to indicate the statistics related to the selected model.

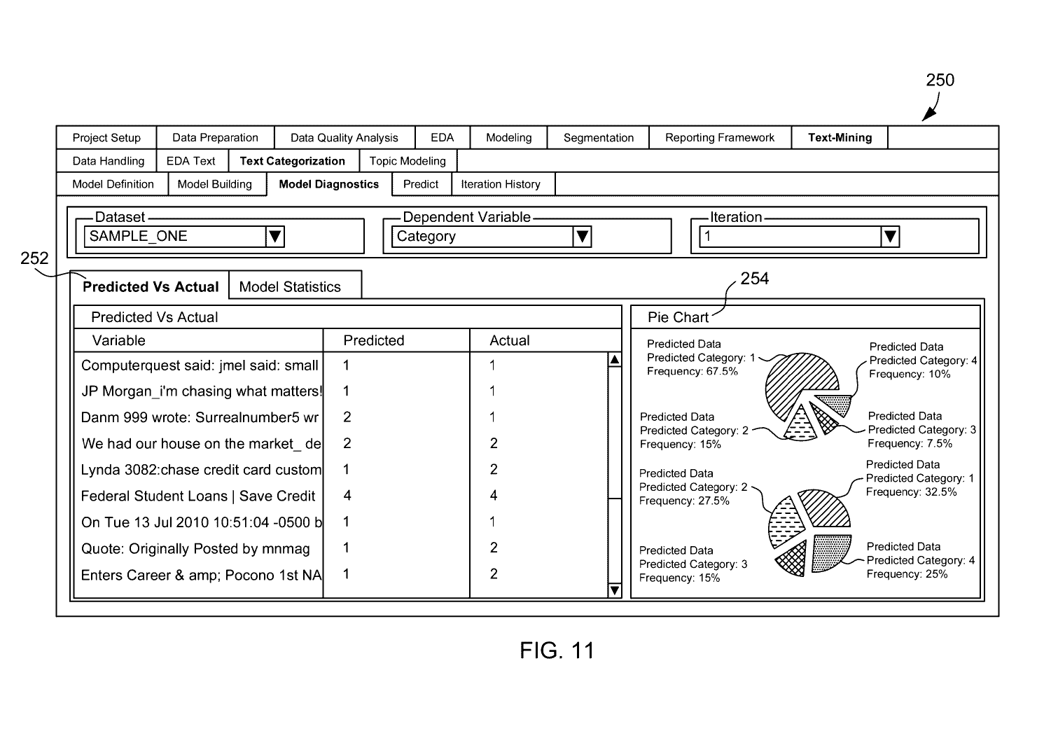

FIG. 11 is an example model diagnostic screen of a text mining tool implemented according to aspects of the present technique. As illustrated, once the model is build it is further evaluated based on the model statistics as part of the model diagnostics using the model diagnostic screen 250. The model is evaluated using the predicted versus the actual data related to a particular model as shown using pane 252. The same evaluation can also be viewed using several visualizations like pie chart (cell 254).

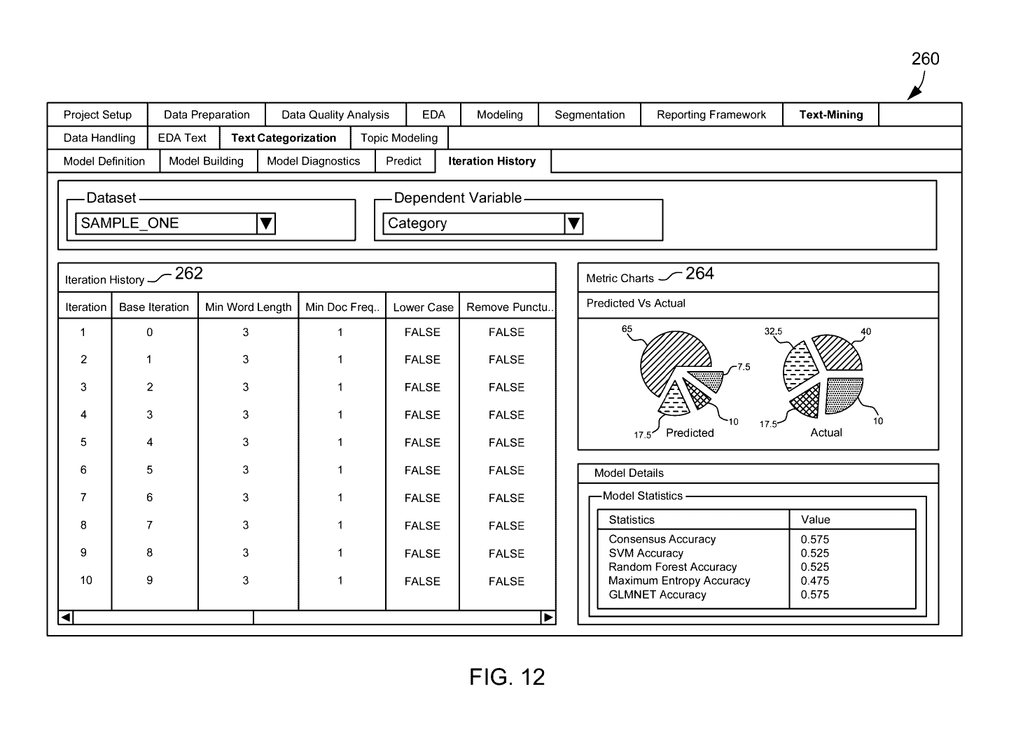

FIG. 12 is an example iteration history viewing screen of a text mining tool implemented according to aspects of the present technique. Once the model diagnostics are performed as described above, it is followed by the predict step which requires scoring on the larger input data set involving model section to categorize the text. The outcome of the predict step leads to the iteration history which facilitates the comparison of various iterations (cell 262) with the help of tables and charts (cell 264).

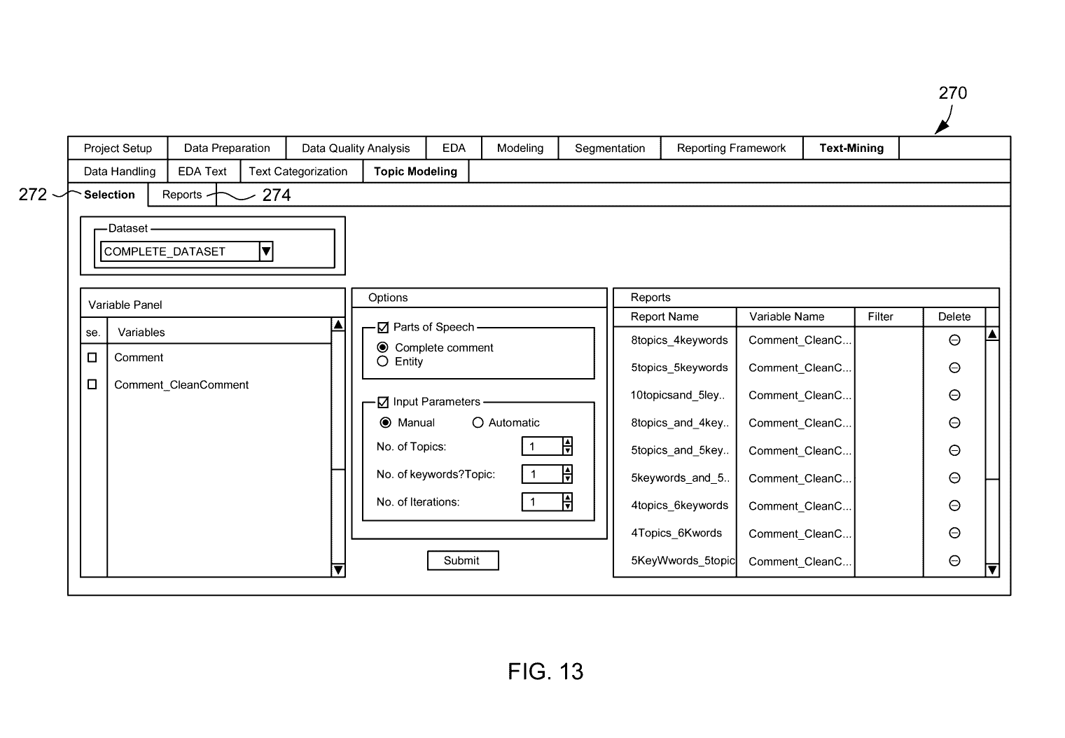

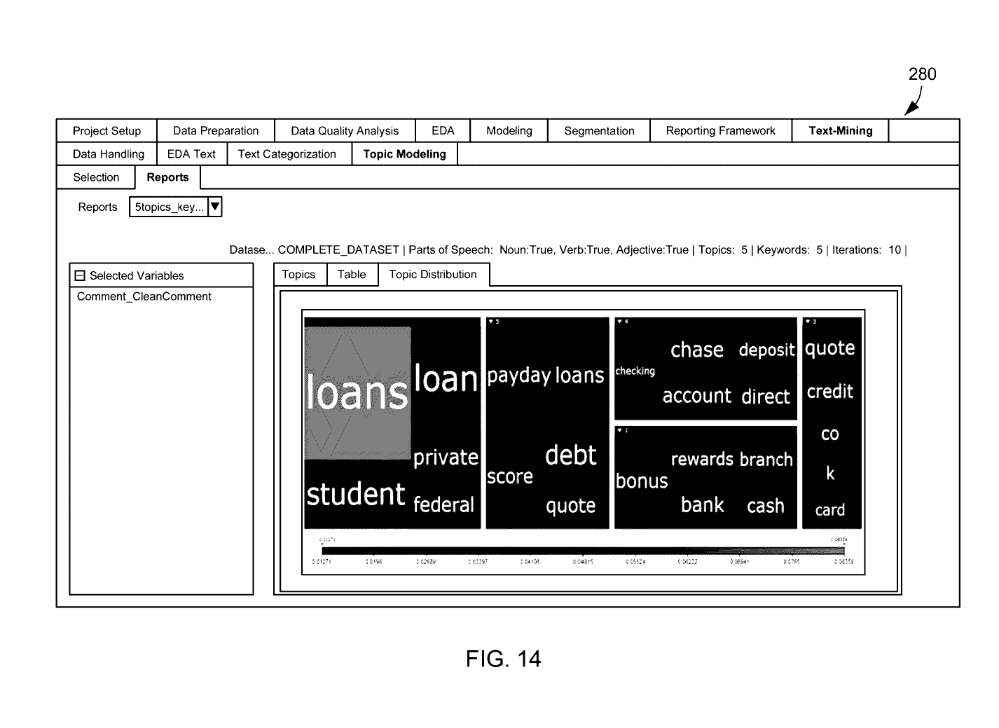

FIG. 13 is an example topic modeling screen of a text mining tool implemented according to aspects of the present technique. The topic modeling screen 270 includes selection (cell 272) and reports (cell 274) field that allows model selection with respect to the number of topics and generates reports based on the one or more criteria selected by the user. In addition, the topic modeling screen 270 also allows searching and exploring a collection of documents based on pre-defined themes. Reports can be generated as an outcome of the topic modeling which allows viewing topic and keywords per topic as word cloud as well as provides possibility to view topic distribution chart as shown in FIG. 14 (topic distribution screen 280).

The above described systems provide several advantages including handling of data sets in multiple languages. In addition, the technique described herein provides for categorization of data into specified categories using actual categorization techniques and predictive techniques. Further, the techniques described herein also include modelling of words repeatedly occurring in the text under different themes, etc.

The technique described above can be performed by the text mining system described in FIG. 1 and FIG. 3. The technique described above may be embodied as devices, systems, methods, and/or computer program products. Accordingly, some or all of the subject matter described above may be embodied in hardware and/or in software (including firmware, resident software, micro-code, state machines, gate arrays, etc.) Furthermore, the subject matter may take the form of a computer program product such as an analytical tool, on a computer-usable or computer-readable storage medium having computer-usable or computer-readable program code embodied in the medium for use by or in connection with an instruction execution system. In the context of this description, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

When the subject matter is embodied in the general context of computer-executable instructions, the embodiment may comprise program modules, executed by one or more systems, computers, or other devices. Generally, program modules include routines, programs, objects, components, data structures, etc. that performs particular tasks or implement particular abstract data types. Typically, the functionality of the program modules may be combined or distributed as desired in various embodiments.

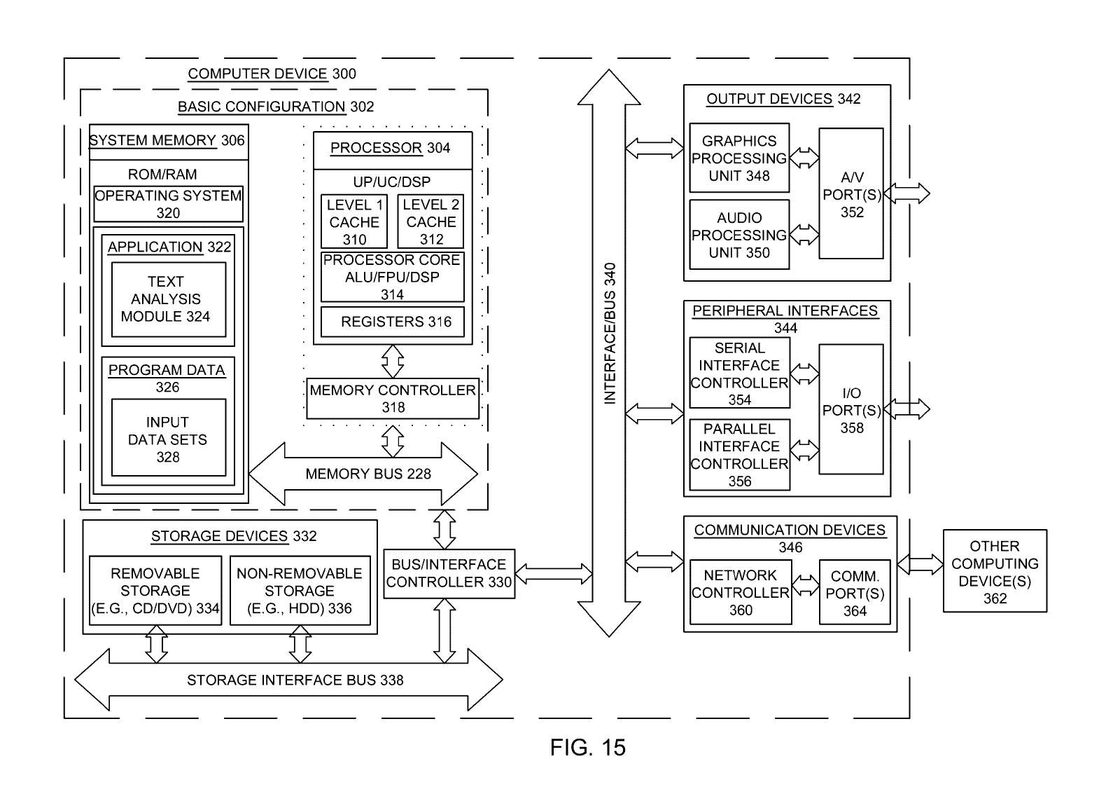

FIG. 15 is a block diagram of an example computing system 300 that is arranged for extracting relevant text from a plurality of input data sets in accordance with the present technique is shown. In a very basic configuration 302, computing system 300 typically includes one or more processors 304 and a system memory 306. A memory bus 308 may be used for communicating between processor 304 and system memory 306.

Depending on the desired configuration, processor 304 may be of any type including but not limited to a microprocessor (μP), a microcontroller (μC), a digital signal processor (DSP), or any combination thereof. Processor 304 may include one or more levels of caching, such as a level one cache 310 and a level two cache 312, a processor core 314, and registers 316. An example processor core 314 may include an arithmetic logic unit (ALU), a floating point unit (FPU), a digital signal processing core (DSP Core), or any combination thereof. An example memory controller 318 may also be used with processor 304, or in some implementations memory controller 318 may be an internal part of processor 304.

Depending on the desired configuration, system memory 306 may be of any type including but not limited to volatile memory (such as RAM), non-volatile memory (such as ROM, flash memory, etc.) or any combination thereof. System memory 306 may include an operating system 320, a text analysis module 324 as an application 322 and a plurality of input data sets 328 as a program data 326.

Text analysis module 324 is configured to receive the input data sets 328 and to generate an output data set by analyzing the input data sets 328. This described basic configuration 302 is illustrated in FIG. 15 by those components within the inner dashed line.

Computing system 300 may have additional features or functionality, and additional interfaces to facilitate communications between basic configuration 302 and any required devices and interfaces. For example, a bus/interface controller 330 may be used to facilitate communications between basic configuration 302 and one or more data storage devices 332 via a storage interface bus 338. Data storage devices 332 may be removable storage devices 334, non-removable storage devices 336, or a combination thereof.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 306, removable storage devices 334 and non-removable storage devices 336 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing system 300. Any such computer storage media may be part of the computing system 300.

Computing system 300 may also include an interface bus 340 for facilitating communication from various interface devices (e.g., output devices 342, peripheral interfaces 344, and communication devices 346) to basic configuration 302 via bus/interface controller 330. Example output devices 342 include a graphics processing unit 348 and an audio processing unit 350, which may be configured to communicate to various external devices such as a display or speakers via one or more A/V ports 352.

Example peripheral interfaces 344 include a serial interface controller 354 or a parallel interface controller 356, which may be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which may be arranged to facilitate communications with one or more other computing device(s) 362 over a network communication link via one or more communication ports 364.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing system 300 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. It may be noted that computing system 300 may also be implemented as a personal computer including both laptop computer and non-laptop computer configurations.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated and described herein, many modifications and changes will occur to those skilled in the art. It is, therefore, to be understood that the appended claims are intended to cover all such modifications and changes as fall within the true spirit of the invention.

1. A text mining system for extracting relevant text from a plurality of input data sets, the system comprising:
an input interface module configured to enable one or more users to select a plurality of sources for a plurality of input data sets;
a text analysis module configured to receive the plurality of input data sets and to generate an output data set by analyzing the plurality of input data sets, the text analysis module comprising:
a data handling module configured to convert the plurality of input data sets to an analytics text set;
an exploratory analysis module configured to determine a plurality of correlations within the analytics text set;
a topic modeling module configured to identify a plurality of topics repeatedly occurring in the analytics text set; and
a reporting module configured to generate a plurality of reports for the text analysis module; and
memory circuitry configured to store the plurality of input data sets, the analytics text set and the output data set.

2. The system of claim 1, wherein the data handling module is further configured to perform a pre-processing task by filtering non-relevant elements from the plurality of input data sets.

3. The system of claim 1, wherein the text analysis module further comprises a text categorization module configured to generate a plurality of models based on the results of the exploratory analysis module; wherein each model provides one or more categorized text sets to achieve a pre-defined goal determined by a user.

4. The system of claim 3, wherein the text categorization module is further configured to categorize the analytics text set by:
creating an actual categorization module by identifying a plurality of categories for a sample data set; and
creating a predictive categorization module by applying the identified categories on the analytics text set; wherein the sample data set is a subset of the analytics text set.

5. The system of claim 3, wherein the text categorization module is further configured to compare the actual categorization module and the predictive categorization module in an iterative manner.

6. The system of claim 1, wherein the exploratory analysis module is configured to perform a frequency analysis on the analytics text set to determine frequently occurring unigrams, bigrams and texts with frequency in the specified range.

7. The system of claim 1, wherein the exploratory analysis module is configured to perform a relationship analysis on the analytics text set to determine an association score representing correlation between words in the analytics text set.

8. The system of claim 1, wherein the exploratory analysis module is further configured to generate visual representations corresponding to the frequency analysis and relationship analysis in form of bar charts, text tag cloud, tables or combinations thereof.

9. The system of claim 1, wherein the topic modeling module identifies the plurality of topics repeatedly occurring in the analytics text set using a plurality of machine learning algorithms.

10. The system of claim 1, wherein the reporting module is further configured to enable the users to access a plurality of reports generated by the text analysis module.

11. The system of claim 1, wherein the text analysis module is configured to operate on a plurality of languages.

12. A text mining tool for extracting relevant text from a plurality of input data sets, the text mining tool comprising:
an input interface module configured to enable a user to select a plurality of sources for a plurality of input data sets;
a data handling interface configured to enable the user to select one or more variables to trigger a data handling task, wherein the data handling task converts the plurality of input data sets to an analytics text set;
an exploratory analysis interface configured to enable the user to select one or more types of analysis to trigger exploratory analysis task wherein the exploratory analysis task determines a plurality of correlations within the analytics text set;
a topic modeling interface configured to enable the user to select one or more input parameters to trigger topic modeling task wherein the topic modeling task identifies a plurality of topics repeatedly occurring in the analytics text set; and
a reporting interface configured to generate a plurality of reports based on selected criteria.

13. The text mining tool of claim 12, wherein the data handling interface is further configured to enable the user to select between one or more data cleansing task.

14. The text mining tool of claim 12, wherein the exploratory analysis interface is further configured to enable the user to select between a frequency analysis and a relationship analysis.

15. The text mining tool of claim 12, wherein the text analysis module is configured to analyze input data sets in a plurality of languages.

16. A method for extracting relevant text from a plurality of input data sets, the method comprising:
selecting a plurality of input data sets from a plurality of sources;
converting the plurality of input data sets to generate an analytics text set;
determining correlations existing within the analytics text set by performing exploratory analysis;
generating one or more models based on the results of the exploratory analysis;
performing topic modeling to identify repeatedly occurring topics in the analytics text set;
generating a plurality of reports based on selected criteria; and
generating an output data set.

17. The method of claim 16, further comprising performing a frequency analysis on the analytics text set to determine frequently occurring unigrams, bigrams and texts with frequency in the specified range.

18. The method of claim 16, further comprising performing a relationship analysis on the analytics text set to determine an association score representing correlation between words in the analytics text set.

19. The method of claim 16, further comprising storing the plurality of reports to enable the user to access the plurality of reports from a single location.

20. The method of claim 16, wherein the plurality of input data sets is multi-lingual.
